(19) United States
(12) Patent Application Publication
(10) Pub. No.: US 2026/0004755 A1
(43) Pub. Date: Jan. 1, 2026

(54) DISPLAY APPARATUS AND CONTROL METHOD THEREOF

(71) Applicant: SAMSUNG ELECTRONICS CO., LTD., Suwon-si (KR)

(72) Inventors: Wonseok SONG, Suwon-si (KR); Woonsung PARK, Suwon-si (KR); Yoosun JUNG, Suwon-si (KR)

(73) Assignee: SAMSUNG ELECTRONICS CO., LTD., Suwon-si (KR)

(21) Appl. No.: 19/322,063

(22) Filed: Sep. 8, 2025

Related U.S. Application Data
(63) Continuation of application No. PCT/KR2024/001027, filed on Jan. 22, 2024.

(30) Foreign Application Priority Data
Mar. 10, 2023 (KR) 10-2023-0031916

(51) Int. Cl. G09G 5/00

(52) U.S. Cl. CPC G09G 5/003; G09G 2320/0261; G09G 2340/16; G09G 2360/18

(57) ABSTRACT

A display apparatus may include a frame buffer configured to sequentially receive a plurality of image frames, and a processor configured to receive the plurality of image frames from the frame buffer and identify whether a skipped frame has been generated based on the plurality of image frames, based on generation of the skipped frame, generate a predicted frame based on a preceding frame of the skipped frame among the plurality of image frames and motion information of the preceding frame, and control a display to output the predicted frame replacing the skipped frame.

### CROSS-REFERENCE TO RELATED APPLICATION

This application is a continuation application of International Patent Application No. PCT/KR2024/001027, filed on Jan. 22, 2024, which claims priority from Korean Patent Application No. 10-2023-0031916, filed on Mar. 10, 2023, in the Korean Intellectual Property Office, the disclosures of which are incorporated herein by reference in their entireties.

### BACKGROUND

The disclosure relates to a display apparatus for compensating for frame skipping and a control method thereof.

A display apparatus is generally an output device that visually presents received or stored image information to users. The display apparatus is used in a variety of environments, including homes and workplaces.

Examples of display apparatuses include a monitor connected to a personal computer (PC), a server computer or the like, a portable computer, a navigation terminal, a television, an Internet Protocol Television (IPTV), a handy terminal (e.g., a smart phone, a tablet PC, Personal Digital Assistant (PDA), or a cellular phone), various kinds of displays used to reproduce images of advertisements or movies in industrial fields, and various kinds of audio/video systems.

Meanwhile, while a display apparatus receives a plurality of frames to display images, a phenomenon known as frame skipping may occur in which some frames are missing or damaged.

To resolve the frame skipping phenomenon, conventional display apparatuses have compensated for skipped frames based on the preceding and following frames of the skipped frames.

However, the method of compensating for frames based on the preceding and following frames has had drawbacks, such as inefficient use of the frame buffer space and reduced system responsiveness.

### SUMMARY

In one more embodiments of the present disclosure, a display apparatus may include: a frame buffer configured to sequentially receive a plurality of image frames; and a processor configured to: receive the plurality of image frames from the frame buffer and identify whether a skipped frame has been generated based on the plurality of image frames; based on generation of the skipped frame, generate a predicted frame based on a preceding frame of the skipped frame among the plurality of image frames and motion information of the preceding frame; and control a display to output the predicted frame replacing the skipped frame.

In one more embodiments of the present disclosure, a method of controlling a display apparatus may include: sequentially receiving a plurality of image frames; identifying at least one skipped frame from among the plurality of image frames; generating a predicted frame based on motion information of the plurality of image frames; and replacing the skipped frame with the predicted frame and outputting the predicted frame on a display.

In one more embodiments of the present disclosure, a display apparatus may include: a frame buffer configured to sequentially receive a plurality of image frames; and a processor configured to receive the plurality of image frames from the frame buffer and generate a predicted frame based on the plurality of image frames, wherein the processor may be configured to: identify an output location of the predicted frame by detecting an image frame conversion rate; generate the predicted frame based on a preceding frame of a frame corresponding to the output location and motion information of the preceding frame; and output the predicted frame at the output location of the predicted frame.

### BRIEF DESCRIPTION OF THE DRAWINGS

The above and/or other aspects will be more apparent by describing certain example embodiments, with reference to the accompanying drawings, in which:

FIG. 1 shows an appearance of a display apparatus according to an embodiment.

FIG. 2 is a control block diagram of a display apparatus according to an embodiment.

FIG. 3 is a detailed block diagram showing removing motion judder, performed by a controller of a display apparatus according to an embodiment.

FIG. 4 is a flowchart showing processing one frame skip, performed by a display apparatus according to an embodiment.

FIG. 5 is a flowchart showing processing one frame skip and a delayed frame input after the frame skip, performed by a display apparatus according to an embodiment.

FIG. 6 is a flowchart showing processing two frame skips, performed by a display apparatus according to an embodiment.

FIG. 7 is a flowchart showing processing two frame skips and a delayed frame input after the frame skips, performed by a display apparatus according to an embodiment.

FIG. 8 is a flowchart showing processing two frame skips and a delayed frame input after the frame skips, performed by a display apparatus according to an embodiment.

FIG. 9 shows a case in which a display apparatus according to an embodiment is applied to a frame rate converter.

FIG. 10 shows a control flowchart of a display apparatus according to an embodiment.

FIG. 11 shows a control flowchart of a case in which a display apparatus according to an embodiment is applied to a frame rate converter.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

In the present disclosure, the term “an embodiment” is intended to encompass one or more embodiments, rather than being limited to a single example. Furthermore, features described in embodiments may be combined and implemented together.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, such terms as “1st” and “2nd,” or “first” and “second” may be used to simply distinguish a corresponding component from another, and does not limit the components in other aspect (for example, importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it means that the component may be coupled with the other component directly or indirectly via a third component.

Throughout the specification, when a member is referred to as being “on” another member, the member is in contact with another member or yet another member is interposed between the two members.

The term “and/or” includes combinations of one or all of a plurality of associated listed items.

One or more embodiments of the present disclosure provide a display apparatus and a control method thereof, capable of reproducing the original image while suppressing motion judder by outputting a predicted frame in place of a skipped frame.

According to an aspect of the present disclosure, it is possible to reproduce the original image while reducing motion judder by outputting a predicted frame to replace a skipped frame.

The display apparatus 1 may be at least one of various types of home appliances. For example, the display apparatus 1 may, as shown in the accompanying drawings, include a refrigerator, a dishwasher, an electric range, an electric oven, an air conditioner, a clothing care apparatus, a washing machine, a dryer, and a microwave oven, without being limited thereto. For example, the display apparatus 1 may include various types of appliances not shown in the drawings, such as a cleaning robot, a vacuum cleaner, a television, and the like. Furthermore, the aforedescribed home appliances are only examples.

The display apparatus 1 may communicate with a server, and the server may include a communication module capable of communicating with another server, the display apparatus 1, or a user device, at least one processor capable of processing data received from another server, the display apparatus 1, or a user device, and at least one memory capable of storing a program for processing data or processed data. The server may be implemented as a variety of computing devices, such as a workstation, a cloud, a data drive, a data station, and the like. The server may be implemented as one or more server physically or logically separated based on a function, detailed configuration of function, or data, and may transmit and receive data through communication between servers and process the transmitted and received data.

The server may perform functions such as managing a user account, registering the display apparatus 1 in association with the user account, managing or controlling the registered display apparatus 1, and the like. For example, a user may access the server via the user device and may generate a user account. The user account may be identified by an identifier (ID) and a password set by the user. The server may register the display apparatus 1 to the user account according to a predetermined procedure. For example, the server may link identification information (such as a serial number or media access control (MAC) address) of the display apparatus 1 to the user account to register, manage, and control the display apparatus 1. The user device may include a communication module capable of communicating with the server, a user interface receiving a user input or outputting information to a user, at least one processor controlling an operation of the user device, and at least one memory storing a program for controlling the operation of the user device.

The user device may be carried by a user, or placed in a user's home or office, or the like. The user device may include a personal computer, a terminal, a portable telephone, a smartphone, a handheld device, a wearable device, and the like, without being limited thereto.

The memory of the user device may store a program (e.g., an application) for controlling other display apparatus 1. The application may be sold installed on the user device, or may be downloaded from an external server for installation.

By executing the application installed on the user device by a user, the user may access the server, generate a user account, and perform communication with the server based on the login user account to register the display apparatus 1.

For example, by operating the display apparatus 1 to enable other home appliances to access the server according to a procedure guided by the application installed on the user device, the server may register the display apparatus 1 with the user account by assigning the identification information (such as a serial number or MAC address) of other home appliances to the corresponding user account.

A user may control the display apparatus 1 using the application installed on the user device. For example, by logging into a user account with the application installed on the user device, the display apparatus 1 registered in the user account appears, and by inputting a control command for the display apparatus 1, the control command may be delivered to the display apparatus 1 via the server.

A network may include both a wired network and a wireless network. The wired network may include a cable network or a telephone network, and the wireless network may include any networks transmitting and receiving a signal via radio waves. The wired network and the wireless network may be connected to each other.

The network may include a Wide Area Network (WAN) such as the Internet, a Local Area Network (LAN) formed around an Access Point (AP), and a short range wireless network not using an AP. The short range wireless network may include Bluetooth (IEEE 802.15.1, Zigbee (IEEE 802.15.4, Wi-Fi Direct, Near Field Communication (NFC), and Z-Wave, without being limited thereto.

The AP may connect the display apparatus 1 or the user device to a WAN connected to the server. The display apparatus 1 or the user device may be connected to the server via a WAN.

The AP may communicate with the display apparatus 1 or the user device using wireless communication such as Wi-Fi (IEEE 802.11, Bluetooth (IEEE 802.15.1, Zigbee (IEEE 802.15.4, and the like, and access a WAN using wired communication, without being limited thereto.

According to various embodiments, the display apparatus 1 may be directly connected to the user device or server without going through an AP.

The display apparatus 1 may be connected to the user device or the server via a long range wireless network or a short range wireless network.

For example, the display apparatus 1 may be connected to the user device via a short range wireless network (e.g., Wi-Fi Direct).

In another example, the display apparatus 1 may be connected to the user device or the server via a WAN using a long range wireless network (e.g., a cellular communication module).

In still another example, the display apparatus 1 may access a WAN using wired communication, and may be connected to other home appliances or the server via a WAN.

Upon accessing a WAN using wired communication, the display apparatus 1 may also act as an access point. Accordingly, the display apparatus 1 may connect other home appliances to a WAN to which the server is connected. Further, other home appliances may connect the display apparatus 1 to the WAN to which the server is connected.

The display apparatus 1 may transmit information about an operation or state to other home appliances, the user device, or the server via the network. For example, the display apparatus 1 may transmit information about an operation or state to other home appliances, the user device or the server upon receiving a request from the server, in response to an event in the display apparatus 1, or periodically or in real time. In response to receiving the information about the operation or state from the display apparatus 1, the server may update the stored information about the operation or state of the display apparatus 1 and transmit the updated information about the operation and state of the display apparatus 1 to the user device via the network. Here, updating the information may include various operations in which existing information is changed, such as adding new information to the existing information, replacing the existing information with new information, and the like.

The display apparatus 1 may obtain various information from other home appliances, the user device, or the server, and may provide the obtained information to a user. For example, the display apparatus 1 may obtain information related to a function of the display apparatus 1 (e.g., recipes, washing instructions, and the like) from the server and various environment information (e.g., weather, temperature, humidity, and the like), and may output the obtained information via a user interface.

The display apparatus 1 may operate according to a control command received from other home appliances, the user device, or the server. For example, the display apparatus 1 may operate in accordance with a control command received from the server, based on a prior authorization obtained from a user to operate in accordance with the control command of the server even without a user input. Here, the control command received from the server may include a control command input by the user via the user device or a control command based on preset conditions, without being limited thereto.

The user device may transmit information about a user to the display apparatus 1 or the server through the communication module. For example, the user device may transmit information about a user's location, a user's health status, a user's preference, a user's schedule, and the like to the server. The user device may transmit information about the user to the server based on the user's prior authorization.

The display apparatus 1, the user device, or the server may use techniques such as artificial intelligence to determine a control command. For example, the server may receive information about an operation or a state of the display apparatus 1 or information about a user of the user device, process the received information using techniques such as artificial intelligence, and transmit a processing result or a control command to the display apparatus 1 or the user device based on the processing result.

Hereinafter, an operation principle and embodiments of the disclosure will be described with reference to the accompanying drawings.

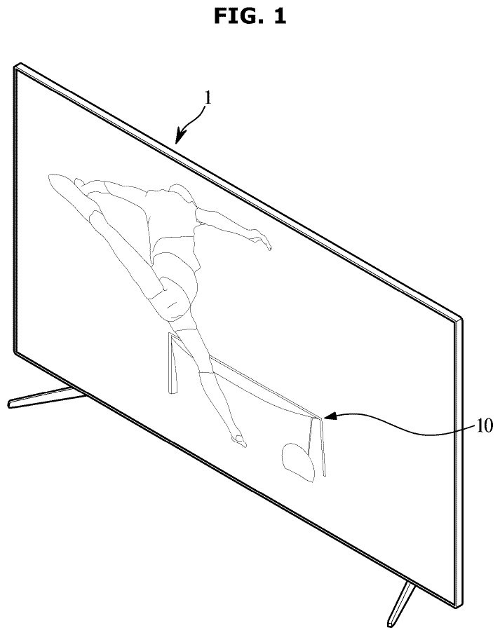

FIG. 1 shows an appearance of a display apparatus 1 according to an embodiment.

The display apparatus 1 may be an apparatus for processing an image signal received from outside and visually displaying a processed image. Hereinafter, a case in which the display apparatus 1 is a television (TV) will be described as an example. However, the display apparatus 1 is not limited to a TV. For example, the display apparatus 1 may be implemented as one of various kinds, such as a monitor, a portable multimedia device, a portable communication device, etc. However, the display apparatus 1 may be any kind of apparatus that visually displays images.

Also, the display apparatus 1 may be a large format display (LFD) that is installed in an outdoor space, such as the top of building or a bus stop. The outdoor space is not limited to open-air spaces, and the display apparatus 1 according to an embodiment may be installed in any place where many people come in and out, such as a subway station, a shopping mall, a theater, an office, a store, etc., although the place is an indoor space.

The display apparatus 1 may receive content including a video signal and an audio signal from various content sources, and output video and audio corresponding to the video signal and audio signal. For example, the display apparatus 1 may receive content data through a broadcasting reception antenna or a wired cable, receive content data from a content reproducing apparatus, or receive content data from a content providing server of a content provider.

As shown in FIG. 1, the display apparatus 1 may include a main body and a screen 10 that displays images.

The main body may form an appearance of the display apparatus 1, and components for enabling the display apparatus 1 to display an image or perform various functions may be provided inside the main body. The main body shown in FIG. 1 may be in a shape of a flat plate. However, the shape of the main body is not limited to the flat plate shown in FIG. 1. For example, the main body may be in a shape of a curved plate.

The screen 10 may be formed on a front surface of the main body and display an image. For example, a still image or a moving image may be displayed on the screen 10, and an image may be configured with a plurality of frames. Also, the screen 10 may display a two-dimensional planar image or a three-dimensional stereoscopic image using a user's binocular disparity.

The screen 10 may include, for example, a self-emissive panel (for example, a light-emitting diode panel or an organic light-emitting diode panel) that itself emits light, or a non-emissive panel (for example, a liquid crystal panel) that transmits or blocks light emitted by a light source (for example, a backlight unit), etc.

A plurality of pixels may be formed on the screen 10, and an image displayed on the screen 10 may be formed by light emitted from the plurality of pixels. For example, light emitted from the plurality of pixels may be combined like mosaic to form an image on the screen 10.

Each of the plurality of pixels may emit light having different brightness levels and different colors. To emit light having various colors, each of the plurality of pixels may include sub pixels.

The sub pixels may include a red sub pixel capable of emitting red light, a green sub pixel capable of emitting green light, and a blue sub pixel capable of emitting blue light. For example, red light may correspond to light of a wavelength range from about 620 nm (nanometer, one billionth of a meter) to about 750 nm, green light may correspond to light of a wavelength range from about 495 nm to about 570 nm, and blue light may correspond to light of a wavelength range from about 450 nm to about 495 nm.

By a combination of red light from the red sub pixel green light from the green sub pixel and blue light from the blue sub pixel, each of the plurality of pixels may emit light having various brightness levels and various colors.

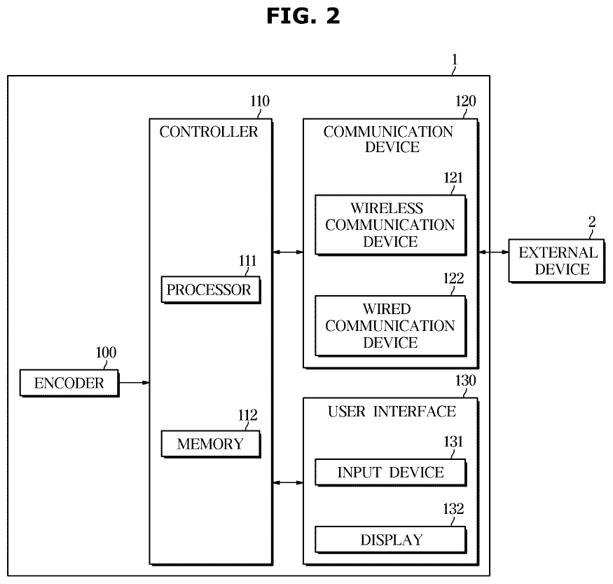

FIG. 2 is a control block diagram of the display apparatus 1 according to an embodiment.

Referring to FIG. 2, the display apparatus 1 according to an embodiment may include an encoder 100, a communication device (e.g., a communication interface) 120, a user interface 130, and a controller 110.

More specifically, the display apparatus 1 may include the encoder 100 that encodes an image, the communication device 120 including a wireless communication device 121 and a wired communication device 122 to communicate with an external device 2, the user interface 130 including an input device 131 that receives a user's command and an output device that displays an image, and the controller 110 electrically connected to the above-mentioned components to control the display apparatus 1.

The encoder 100 may be a component that performs a task of converting video resolution, codec, format, etc. to be suitable for the display apparatus 1 or medium that outputs an image, etc., and the disclosure will describe, but is not limited to, receiving an image from the encoder 100 and removing motion judder.

The communication device 120 may transmit data to the external device 2 or receive data from the external device 2 based on control by the controller 110. For example, the communication device 120 may communicate with a server and/or a user terminal and/or a home appliance included in the external device 2 to transmit and receive various types of data.

To this end, the communication device 120 may establish a direct (e.g., wired) communication channel or a wireless communication channel with an external electronic device (for example, a server, a user terminal, and/or a home appliance), and support communication through the established communication channel. According to an embodiment, the communication device 120 may include a wireless communication device (e.g., a cellular communication module, a short-range communication module, or a global navigation satellite system (GNSS) communication module) 121 or a wired communication device (e.g., a local area network (LAN) communication module or a power line communication module) 122. The communication modules may communicate with the external device 2 through a first network (e.g., a short-range communication network, such as Bluetooth, WiFi Direct, or Infrared data association (IrDA)) or a second network (e.g., a long-distance communication network, such as a legacy cellular network, a fifth generation (5G) network, a next generation communication network, the Internet, or a computer network (e.g., a LAN or a wide area network (WAN)). These various kinds of communication modules may be integrated into a single component (e.g., a single chip) or implemented with a plurality of separate components (e.g., a plurality of chips).

The user interface 130 may be configured with an input device 131 and a display 132 and may provide an interface to allow a user to interact with the display apparatus 1.

The display 132 may include a screen to output an image and may be included in various home appliances as described above.

The controller 110 may include a processor 111 that generates control signals related to operations of the display apparatus 1, and a memory 112 that stores programs, applications, instructions, and/or data for operations of the display apparatus 1. The processor 111 and the memory 112 may be implemented as separate semiconductor devices or may be integrated into a single semiconductor device. Also, the controller 110 may include a plurality of processors 111 or a plurality of memories 112. The controller 110 may be positioned at various locations of the display apparatus 1.

The processor 111 may include an arithmetic circuit, a memory circuit, and a control circuit. The processor 111 may include one chip or a plurality of chips. Also, the processor 111 may include one core or a plurality of cores.

The memory 112 may store a program for controlling the display apparatus 1 according to a user command, and data including settings of the display apparatus 1 based on input values. Also, the memory 112 may include a frame buffer 112-1 that stores a plurality of image frames received from the encoder 100.

The memory 112 may include a volatile memory 112, such as Static Random Access Memory (S-RAM) and Dynamic Random Access Memory (D-RAM), and a non-volatile memory 112, such as Read Only Memory (ROM) and Erasable Programmable Read Only Memory (EPROM). The memory 112 may include a single memory device 112 or a plurality of memory devices 112.

The processor 111 may process data and/or a signal by using a program provided from the memory 112 and transmit a control signal to each component of the display apparatus 1 based on the processed result.

The controller 110 including the processor 111 and the memory 112 may receive a plurality of image frames from the frame buffer 112-1 and determine whether a skipped frame has occurred based on the received plurality of image frames. Upon detecting a skipped frame, the controller 110 may generate a predicted frame based on a preceding frame of the skipped frame among the plurality of image frames and motion information of the preceding frame, and output the predicted frame replacing the skipped frame on the display 132.

The controller 110 may identify a specific image frame among the plurality of image frames as a skipped frame based on motion information of an immediately preceding frame of the image frame.

Therefore, the display apparatus 1 according to an embodiment may enable a user to view high-quality images of content with reduced motion judder, which results in an improvement of the user's immersion in the content.

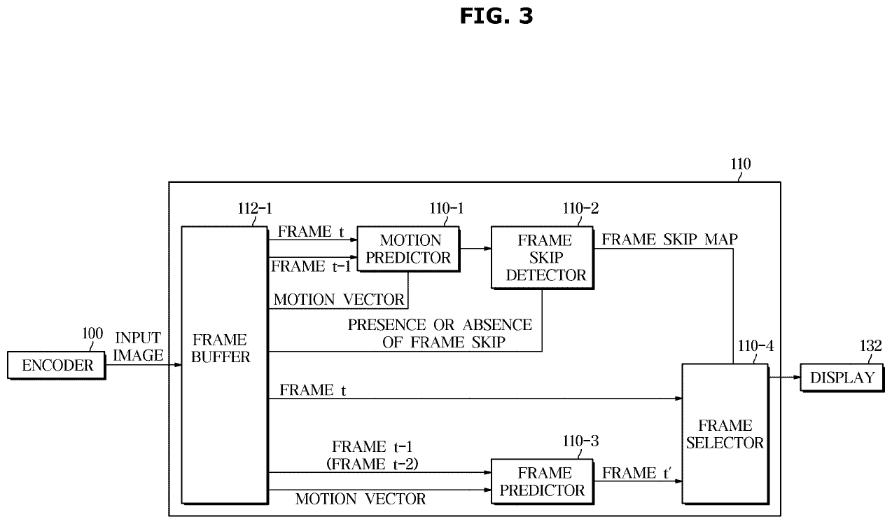

FIG. 3 is a detailed block diagram showing the process of removing motion judder, as performed by the controller 110 of the display apparatus 1 according to an embodiment.

Referring to FIG. 3, to remove motion judder, the display apparatus 1 may identify whether a skipped frame exists in an input image input to the frame buffer 112-1. If a skipped frame is detected, the display apparatus 1 may predict an original form of the skipped frame and output a corresponding predicted frame on the display 132.

Here, motion judder refers to a phenomenon in which motion shakes when an object moves quickly on the display apparatus 1 and may refer to a phenomenon in which unnaturalness of motion occurs, such as shaking of an image or unnatural interruption in an expression of movement.

Motion judder may be caused by various factors, including limitations in the performance of the display apparatus 1, hardware performance mismatches during playback of high-resolution or high-bitrate content that exceeds a normal range of use, or frame skips that occur during video editing or transmission.

A frame skip occurs when data for a specific frame is missing from an image sequence. Causes of frame skips include a case in which an image generator fails to generate a frame at a corresponding time during an image generation process and a case in which information on a specific frame is lost due to instability in a transmission environment during an image transmission process. When a frame skip has occurred, most image generation and transmission apparatuses output a preceding frame repetitively and therefore, in a section where a frame skip has occurred, a still image is output. When a frame skip has occurred in an original image section with motion, a still section is generated during motion, which causes motion judder. Frame skip compensation is a technology of removing motion judder by removing a frame where a skip has occurred and replacing the frame with an image having appropriate motion.

Because an existing technology intentionally causes a frame skip to reduce an amount of information in an image encoding operation without compensating for a frame skip that has occurred unexpectedly during an image generation and transmission process, the existing technology does not compensate for a frame skip unintentionally occurred. Also, because the existing technology removes motion judder caused by frame skips only by applying a frame delay greater than the number of frame skips that may occur consecutively, latency between an input image and an output image increases and a memory 112 (e.g., a frame butter 112-1) corresponding to the number of delayed frames is required to store the delayed frames, resulting in waste of storage space.

Meanwhile, the display apparatus 1 according to an embodiment may provide a real-time motion judder removing device that detects a frame skip occurred during an image transmission process and compensates for the detected frame skip by a frame prediction technology to output a smooth image without motion judder.

The controller 110 may include a frame buffer 112-1, a motion predictor 110-1, a frame skip detector 110-2, a frame predictor 110-3, and a frame selector 110-4. The controller 110 may receive an input image from the encoder 100, and the input image, which is configured with a plurality of frames, may be stored in the frame buffer 112-1.

Thereafter, the controller 110 may transfer a frame t (a current frame) and a frame t−1 (a preceding frame) to the motion predictor 110-1. The motion predictor 110-1 may predict motion information such as a motion vector, etc. required for frame interpolation, and transfer the predicted result of motion information to the frame skip detector 110-2.

The frame skip detector 110-2 may analyze the motion information to identify whether a frame skip has occurred. At this time, to prevent a frame delay of a system, whether a frame skip has occurred may be identified locally whenever an image is input, instead of being identified at once after information of all frames is received. Accordingly, a result from the frame skip detector 110-2 may be output in the form of a map representing binary values or weights. In this case, resolution of the map may be a pixel unit or a block unit.

The frame selector 110-4 may select a final output image locally according to a frame skip result. That is, the controller 110 may output the frame t for an image area where no frame skip has occurred, and output, for an area where a frame skip has occurred, a frame t′ predicted by the frame predictor 110-3 based on the frame t−1 (and a frame t−2) and the motion vector. In the case in which a frame skip map received from the frame predictor 110-3 is in the form of weights, the frame selector 110-4 may output a weighted average of the frame t and the frame t′.

The frame skip detector 110-2 may analyze the current frame t, the preceding frame t−1, and the motion information transferred from the motion predictor 110-1 to identify whether a frame skip has occurred. The frame skip detector 110-2 may identify whether two input frames are identical to each other by using a Sum of Absolute Difference (SAD) algorithm. The SAD algorithm may be a method of obtaining a difference image of two frames and then identifying, according to a sum of absolute values of all pixels in the difference image being less than or equal to a reference value, that the two frames are identical to each other.

The frame skip detector 110-2 may use various methods considering noise components in addition to the SAD algorithm. An identification result by the SAD algorithm may be a binary result based on the reference value or may be expressed as a weight such as a probability value between 0 and 1 by inputting a SAD value to a transformation function.

The frame skip detector 110-2 may detect a frame skip locally and output a frame skip result in the form of a map, instead of receiving all frames and detecting a frame skip globally, to prevent a frame delay in a process of detecting a frame skip.

In this case, resolution of the map may be a pixel unit or a block unit. Also, to calculate each pixel component or each block component in the frame skip map, SAD result values may be calculated by using only pixels in a frame t and a frame t−1 around the corresponding pixel or the corresponding block. Therefore, because the frame skip detector 110-2 identifies whether a frame skip has occurred locally on pixels in an image without having to receive all frames, the frame skip detector 110-2 may generate an output image depending on whether a frame skip has occurred, without a frame delay of the entire system.

A case in which an input image includes an overlapping frame may also include a case in which an actual still image is input without any frame skip. Therefore, the frame skip detector 110-2 will not identify that a frame skip has occurred depending on two successive specific frames having the same pixel values.

That is, the frame skip detector 110-2 may identify a case in which a frame t−1 is not identical to a frame t−2 and is identical to a frame t, based on identification results of preceding frames, as a frame skip.

To this end, a frame skip map may be stored in the frame buffer 112-1 to be used to identify a next frame skip. In the case in which a frame skip map is in the form of weights, a value obtained by subtracting a frame skip map t−1 from a converted weight from the SAD may be used to calculate a frame skip map t.

In the case in which a scene change occurs between a frame t−2 and a frame t−1 and an actual still image is input from the frame t−1, the frame skip detector 110-2 may identify that no frame skip has occurred. In this case, the frame skip detector 110-2 may identify whether a frame skip has occurred based on motion information obtained by the motion predictor 110-1. In the case in which a scene change occurs in an input image, a value of a matching cost function may be very large regardless of which motion vector is selected during a matching process in a motion predictor, and therefore, immediately after a scene changes, a frame skip may not be identified although two frames are identical to each other.

In another embodiment, false detection may occur when the motion of an image yield a SAD result value that is close to a reference value (e.g., a predetermined threshold) for identifying a stop. Specifically, this can happen when a difference value between a frame t−1 and a frame t−2 is slightly larger than the reference value and a difference value between the frame t−1 and a frame t is slightly smaller than the reference value.

To prevent or mitigate such false detections, the frame skip detector 110-2 may use two reference thresholds, reference value 1 and reference value 2, to detect a frame skip. If an inter-frame different (i.e., a difference between frames) is larger than the reference value 1, the frame skip detector 110-2 may identify that the frames are not different. If the difference is smaller than the reference value 2, the frame skip detector 110-2 may determine that the frames are the same. If the difference is between the reference value 1 and the reference value 2, no definitive decision is made (i.e., the frame skip detector 110-2 may not determine whether the frames are the same or not). Therefore, the frame skip detector 110-2 may identify only the case in which motion stops momentarily, as a frame skip, except for the case in which a still image is input. In other words, this dual-threshold approach allows the frame skip detector 110-2 to more accurately identify a momentary stop in motion as a frame skip, excluding cases where a static image is input.

Once the frame skip detector 110-2 determines that a frame skip has occurred at a specific time, two methods may be used to determine whether a subsequent frame t+1 is also a skipped frame.

A first method may detect a frame skip by ignoring a frame t where a frame skip has occurred and inputting information on a frame t−1 to the motion predictor 110-1. According to the first method, the same identification criterion as for frame skip detection in a general situation may be applied, and at least two preceding frames from the frame t+1 may be stored in the frame buffer 112-1. A second method may identify a frame t+1 as a frame skip according to the frame t+1 being identified to be the same frame as a frame t in which a frame skip has occurred. According to the second method, the frame skip detector 110-2 may detect frame skips consecutively by using only one preceding frame.

According to the controller 110 identifying that a frame skip has occurred, the controller 110 may predict a frame corresponding to an interpolation time by using a first frame (and a second frame) and a motion vector. In this case, the first frame may be a frame t or a frame t−1, and in the case in which the second frame is used, a frame t−2 may be used. Also, a motion vector used for frame prediction may be calculated by multiplying a reverse motion vector from the frame t−1 toward the frame t−2 under an assumption of linear motion by −1. The controller 110 may use a motion vector to which a secondary motion model, etc. using a motion vector from the frame t−1 toward the frame t−2 and a motion vector from the frame t−2 toward the frame t−3 is applied, instead of the assumption of linear motion.

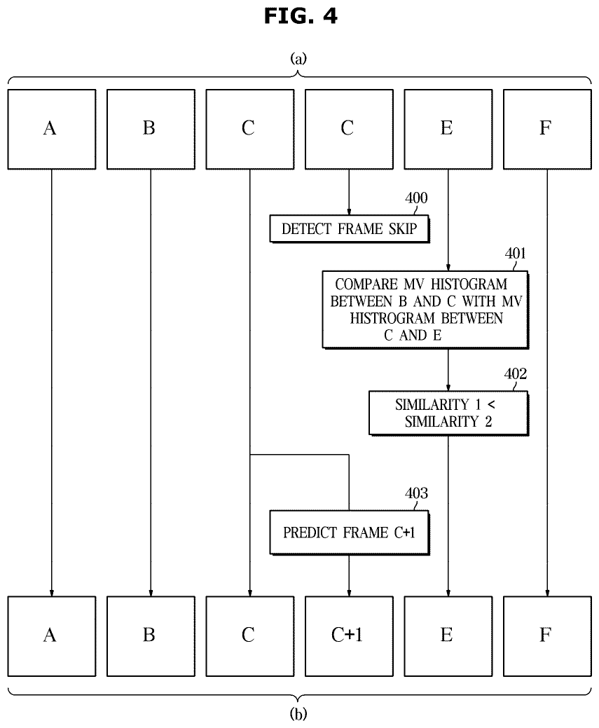

FIG. 4 is a flowchart showing processing one frame skip, as performed by the display apparatus 1 according to an embodiment.

The above-described method of detecting and predicting a frame skip may require an additional operation for completely removing motion judder. For example, in a frame pattern of ABCCDF, where a frame is repeated and a delayed frame is subsequently input, an output location of a frame D is delayed, potentially introducing visual artifacts.

When a delayed frame follows a repeated frame, the controller 110 of the display apparatus 1 according to an embodiment may analyze a motion vector field after the frame repetition to identify an original location of the delayed frame.

In the ABCCDF pattern, when a frame D is input after a repeated frame C, the controller 110 may obtain a motion vector field containing motion information between a frame C and the frame D. At this time, the controller 110 may compare a distribution of motion vectors to a distribution of motion vectors of earlier frames B and C (before the repetition) to identify that the frame D has been delayed and input.

However, not to apply a frame delay, the controller 110 may compare motion vector fields locally and generate an output, and after one frame is completely output, the controller 110 may perform global comparison of motion vector fields to identify whether a currently input frame has been delayed.

To describe a method of identifying an original location of a next frame in the controller 110, an example in which a frame skip pattern of a plurality of input frames (a) is ABCCEF will be described with reference to FIG. 4.

The controller 110 may detect a frame skip of a frame C which is a fourth frame by the above-described method (operation 400). Then, the controller 110 may generate a motion vector histogram between B and C and a motion vector histogram between C and E to identify an original location of a skipped frame. The controller 110 may compare the motion vector histogram between B and C with the motion vector histogram between C and E (operation 401).

At this time, the controller 110 may set similarity between the motion vector histogram between B and C and the motion vector histogram between C and E to first similarity, and set similarity between a histogram obtained by doubling a magnitude of a motion vector between B and C and the motion vector histogram between C and E to second similarity.

In the case of the frame skip pattern of ABCCEF, because no frame delay has occurred and the second similarity is greater than the first similarity (operation 402), the controller 110 may predict a frame C+1 at a location of the frame skip to replace a skipped frame with the frame C+1 (operation 403) and output frames E and F as they are. Accordingly, a plurality of output frames (b) may become ABCC+1EF, wherein the frame C+1 may have similar properties to those of a frame D which is a skipped frame by the motion predictor 110-1.

Hereinafter, a case in which a frame skip and a frame delay have occurred simultaneously will be described.

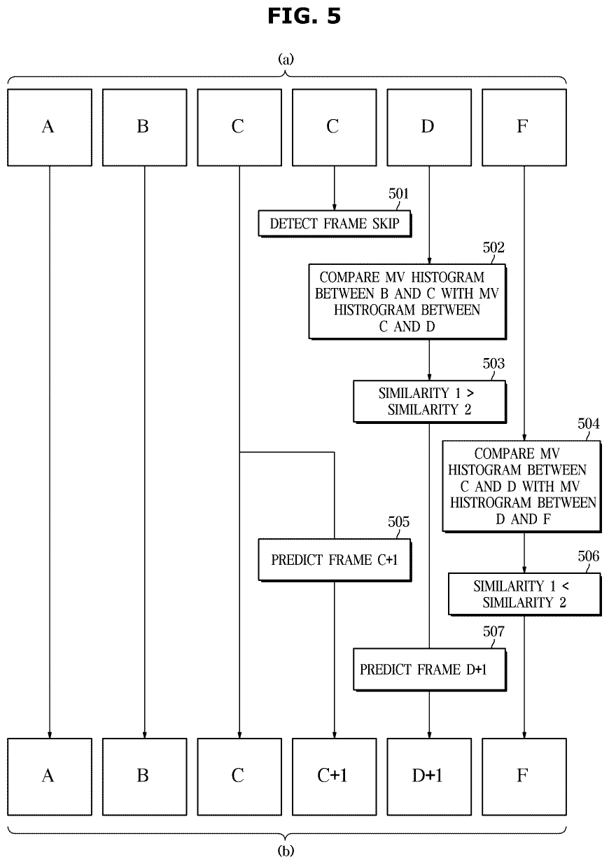

FIG. 5 is a flowchart showing processing one frame skip and a delayed frame input after the frame skip, performed by the display apparatus 1 according to an embodiment.

An example in which a frame skip pattern of a plurality of input frames (a) is ABCCDF will be described with reference to FIG. 5.

The controller 110 may detect a frame skip of a frame C which is a fourth frame by the above-described method (operation 501). Then, to identify an original position of a skipped frame, the controller 110 may generate a motion vector histogram between B and C and a motion vector histogram between C and D. The controller 110 may compare the motion vector histogram between B and C with the motion vector histogram between C and D (operation 502).

At this time, the controller 110 may set similarity between the motion vector histogram between B and C and the motion vector histogram between C and D to first similarity, and set similarity between a histogram obtained by doubling a magnitude of a motion vector between B and C and the motion vector histogram between C and D to second similarity.

In the case of the frame skip pattern of ABCCDF, because a frame delay has occurred and the first similarity is greater than the second similarity (operation 503), the controller 110 may predict a frame C+1 at a location of the frame skip to replace a skipped frame with the frame C+1 (operation 505) and predict a frame D+1 for a delayed frame D to replace the delayed frame D with the frame D+1 (operation 507). At this time, a predicted frame output from the controller 110 may be determined by local comparison between motion vector fields and whether the frame D has been delayed may be finally determined by global comparison between motion vector fields.

Thereafter, the controller 110 may compare histogram similarity by using an input frame F which is a next frame (operation 504). Because the input frame F has not been delayed, the second similarity may be identified to be greater than the first similarity (operation 506), and therefore, the input frame F may be output as it is because an input delay of one frame, which has previously occurred, has been resolved.

Accordingly, a plurality of output frames (b) may become ABCC+1D+1F, wherein the frame C+1 may have similar properties to those of the frame D which is a skipped frame by the motion predictor 110-1 and the frame D+1 may have similar properties to those of the frame E which is a skipped frame by the motion predictor 110-1.

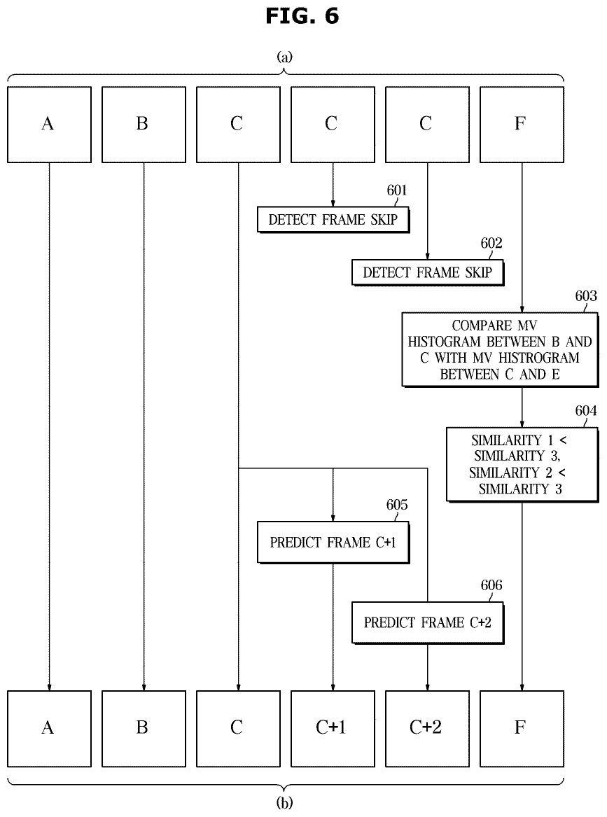

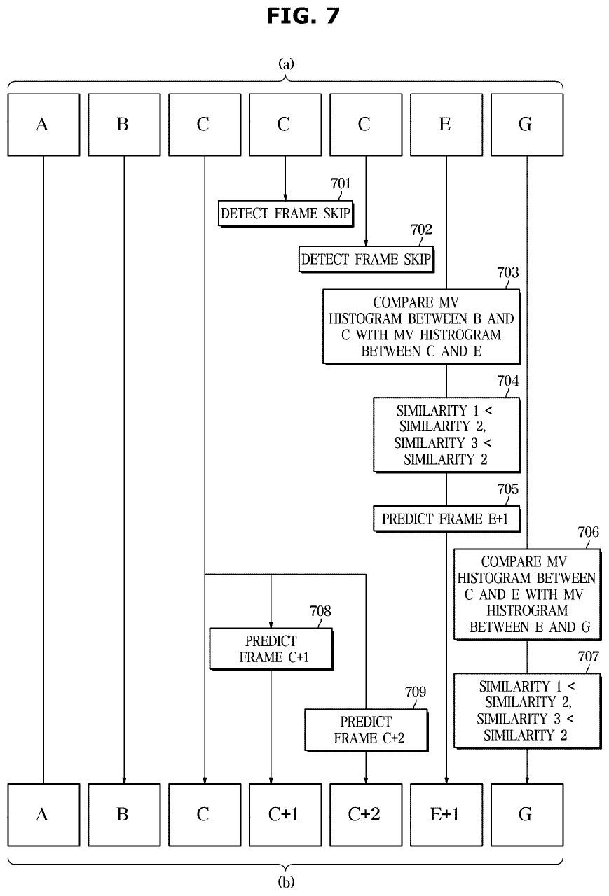

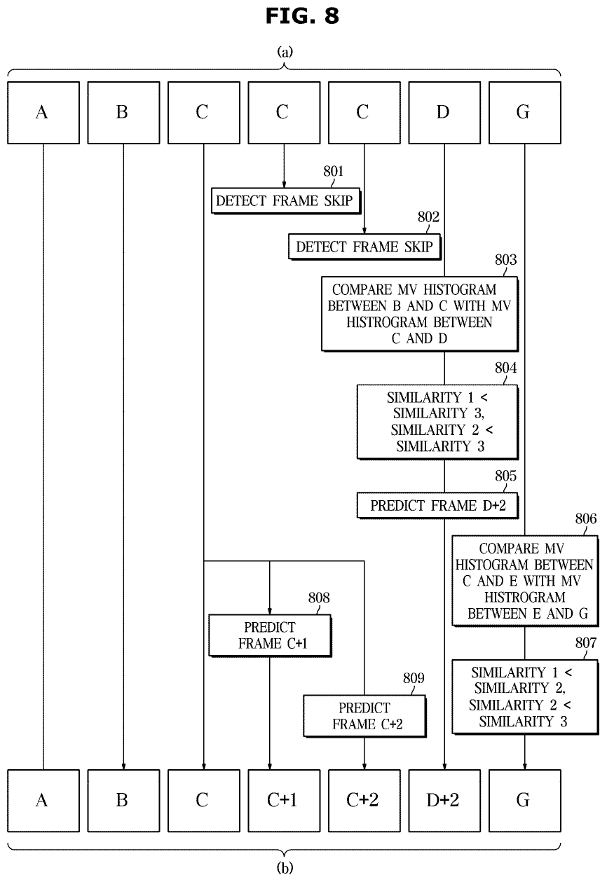

FIG. 6 is a flowchart showing processing two frame skips, performed by the display apparatus 1 according to an embodiment. FIGS. 7 and 8 are flowcharts showing processing two frame skips and a delayed frame input after the frame skips, performed by the display apparatus 1 according to an embodiment.

By extending the above-described method, motion judder may be removed in the same way when two consecutive frames are skipped and an input frame is delayed, such as in a frame skip pattern of ABCCCDG.

According to a plurality of input frames (a) being ABCCCF, the controller 110 may detect frame skips and identify that a second C frame and a third C frame have been skipped (operations 601 and 602).

According to two frame skips being detected, the controller 110 may calculate first similarity which is similarity between a motion vector histogram between B and C and a motion vector histogram between C and D, second similarity between a histogram obtained by doubling a magnitude of a motion vector between B and C and the motion vector histogram between C and D, and third similarity between a histogram which is three times the magnitude of the motion vector between B and C and the motion vector histogram between C and D, and compare the first similarity, the second similarity, and the third similarity to each other (operation 603).

At this time, the controller 110 may identify the third similarity having a greatest value from among the first similarity, the second similarity, and the third similarity (operation 604) and identify a skip pattern ABCCCFG in which two frame skips have occurred and no frame delay has occurred. Accordingly, the controller 110 may output predicted frames C+1 and C+2 at output times of the second and third C frames, respectively (operations 605 and 606), and a plurality of output frames (b) may become ABCC+1C+2F.

Referring to FIG. 7, in the case of a plurality of input frames (a) of ABCCCEG, frame skips may be detected and it may be identified that a second C frame and a third C frame have been skipped (operations 701 and 702).

According to two frame skips being detected, the controller 110 may calculate first similarity, second similarity, and third similarity, and compare the first similarity, the second similarity, and the third similarity to each other (operation 703).

At this time, the controller 110 may identify the second similarity having a greatest value from among the first similarity, the second similarity, and the third similarity (operation 704), and identify a skip pattern of ABCCCEG in which two frame skips have occurred and a frame delay has occurred in a frame E. Accordingly, the controller 110 may output predicted frames C+1 and C+2 at output times of the second and third C frames (operations 708 and 709) and again calculate similarity in a next frame. According to the controller 110 identifying the second similarity having a greatest value, the controller 110 may output a predicted frame E+1 at an output time of the frame E (operation 705).

Thereafter, the controller 110 may compare histogram similarity by using an input frame G which is a next frame (operation 706). At this time, according to the second similarity having a greatest value from among the first similarity, the second similarity, and the third similarity (operation 707), the controller 110 may determine that an input delay of one frame, which has previously occurred, has been resolved and output the input frame G. Accordingly, a plurality of output frames (b) may become ABCC+1C+2E+1G.

Referring to FIG. 8, in the case of a plurality of input frames (a) of ABCCCDG, frame skips may be detected and it may be identified that a second C frame and a third C frame have been skipped (operations 801 and 802).

According to two frame skips being detected, the controller 110 may calculate first similarity, second similarity, and third similarity and compare the first similarity, the second similarity, and the third similarity to each other (operation 803).

According to the third similarity having a greatest value among the first similarity, the second similarity, and the third similarity (operation 804), the controller 110 may identify a skip pattern of ABCCCDG in which two frame skips have occurred and a frame delay has occurred two times in a frame D. Accordingly, the controller 110 may output a predicted frame D+2 at an output time of the frame D (operation 805) and output predicted frames C+1 and C+2 at output times of the second and third C frames (operations 808 and 809).

Thereafter, the controller 110 may compare histogram similarity by using an input frame G which is a next frame (operation 806). At this time, according to the third similarity having a greatest value among the first similarity, the second similarity, and the third similarity (operation 807), the controller 110 may identify that an input delay of one frame, which has previously occurred, has been resolved, and output the input frame G. Accordingly, a plurality of output frames (b) may become ABCC+1C+2D+1G.

There may be various methods of calculating similarity between histograms in FIGS. 4 to 8 and representative examples of the methods may include Correlation, Chi-Square, Intersection, Bhattacharyya Distance, etc.

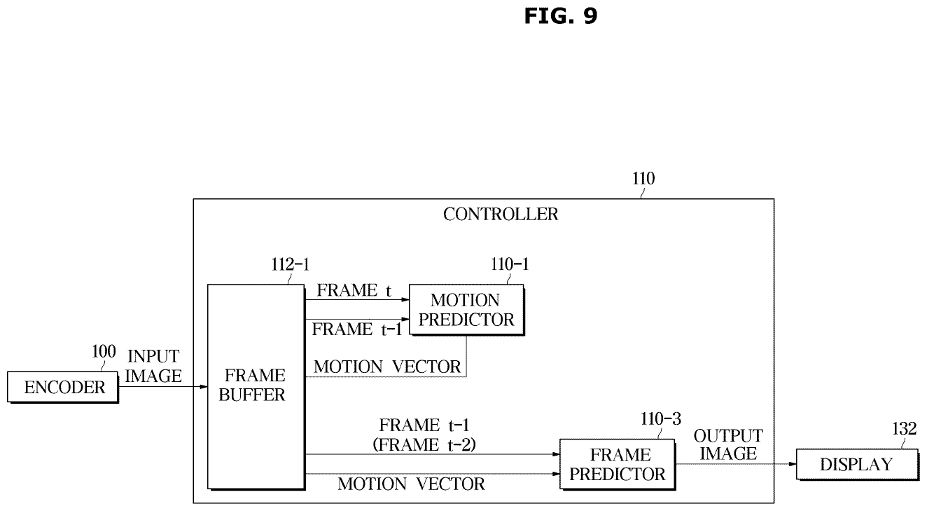

FIG. 9 shows a case in which the display apparatus 1 according to an embodiment is applied to a frame rate converter.

A method of removing motion judder by using frame rate conversion may be performed by the motion predictor 110-1 and the frame predictor 110-3. For example, in the case in which a 60 Hz input image is converted into a 120 Hz image, the 120 Hz image may be output by inserting a ½ time interpolation image between input frames.

At this time, according to a frame skip occurring in an input image, the controller 110 may adjust a frame interpolation time at a corresponding location to remove motion judder caused by the frame skip while performing frame rate conversion. For example, in the case of an input pattern of ABCCEF, the controller 110 may further output ½ time interpolation frames between A and B and between B and C. Thereafter, the controller 110 may output a C+½ time prediction frame between C and C and output a C+1 time predicted frame at an output time of a second C frame. Then, when a frame E is input, the controller 110 may output a ¾ time interpolation frame between C and E and the E frame. In the case in which the controller 110 generates output frames as described above, the order of the output frames may become (A), (½ interpolation of A and B), (B), (½ interpolation of B and C), (C), (C+½ prediction), (C+1 prediction), (¾ interpolation of C and E), (E), (½ interpolation of E and F), and (F).

According to an input image received by the controller 110 being an image of which a frame rate has been converted, the frame rate converter may remove motion judder by detecting frame rate conversion, removing an overlapping frame, and then inserting an interpolation frame.

For example, in the case of an input converted into a 60 Hz image from a 30 Hz image, the input may have a pattern in which frames overlap in pairs, such as AABBCCDD, and the frame rate converter may detect the pattern, designate only frames A, B, C and D as key frames, and then insert interpolation frames between A and B, between B and C, and between C and D by using frame interpolation. At this time, the controller 110 may apply the key frames to frame skip detection to compensate for frame skips and then remove motion judder by performing frame skip compensation and frame rate conversion simultaneously as described above.

A frame rate converter using frame interpolation according to an existing technology may have a frame delay corresponding to at least one frame because the frame rate converter outputs a frame t−0.5 only by receiving a frame t.

Meanwhile, because the display apparatus 1 according to an embodiment outputs a frame t+0.5 at an input time of a frame t based on a frame prediction method, the display apparatus 1 may implement a frame rate converter that does not cause a frame delay of one frame.

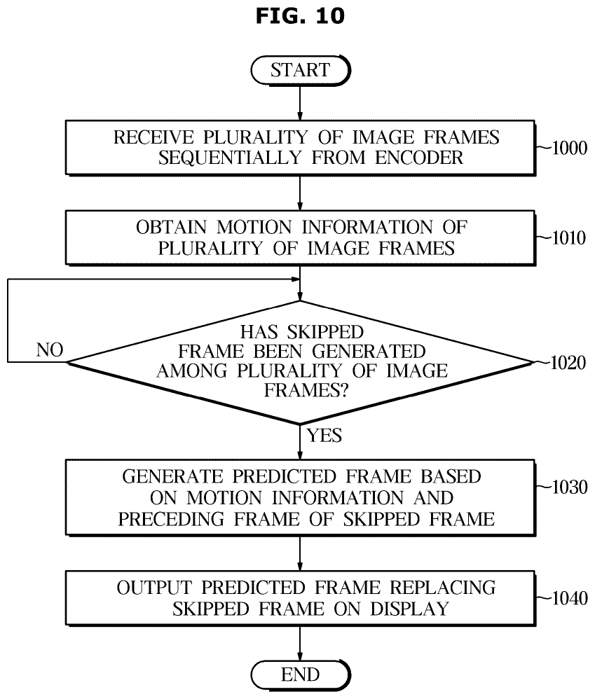

FIG. 10 shows a control flowchart of the display apparatus 1 according to an embodiment.

Referring to FIG. 10, the controller 110 may receive a plurality of image frames sequentially from the encoder 100 (operation 1000). Then, the controller 110 may obtain motion information including a motion vector from each of the plurality of image frames (operation 1010).

The controller 110 may identify whether a skipped frame has been generated among the plurality of image frames (operation 1020), and according to generation of a skipped frame among the plurality of image frames (YES in operation 1020), the controller 110 may generate a predicted frame based on the motion information and a preceding frame of the skipped frame (operation 1030).

Thereafter, the controller 110 may output the predicted frame replacing the skipped frame on the display 132 (operation 1040). Accordingly, the controller 110 may compensate for the skipped frame based on the preceding frame of the skipped frame and remove motion judder.

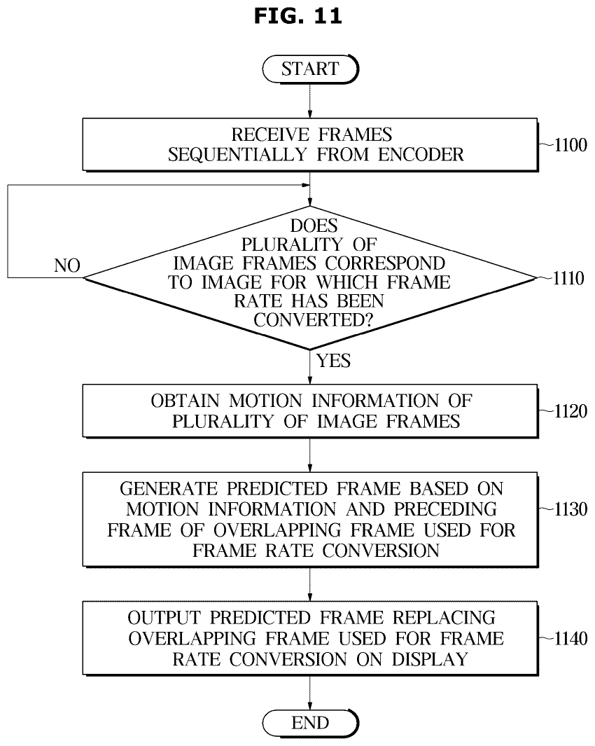

FIG. 11 shows a control flowchart of a case in which the display apparatus 1 according to an embodiment is applied to a frame rate converter.

Referring to FIG. 11, the controller 110 may receive a plurality of image frames sequentially from the encoder 100 (operation 1100). Thereafter, the controller 110 may identify whether the plurality of image frames correspond to an image of which a frame rate has been converted (operation 1110).

According to the plurality of image frames corresponding to an image of which a frame rate has been converted (YES in operation 1110), the controller 110 may obtain motion information of the plurality of image frames (operation 1120).

The controller 110 may generate a predicted frame based on the motion information and a preceding frame of an overlapping frame used for frame rate conversion (operation 1130), as described above with reference to FIG. 10, and output the predicted frame replacing the overlapping frame used for frame rate conversion on the display 132 (operation 1140).

Therefore, the display apparatus 1 according to an embodiment may provide a frame rate converter that does not cause a frame delay.

A display apparatus 1 according to an embodiment may include an encoder 100, a frame buffer 112-1 configured to sequentially receive a plurality of image frames from the encoder 100, and a controller 110 configured to receive the plurality of image frames from the frame buffer and identify whether a skipped frame has been generated based on the plurality of image frames, wherein the controller 110 may be configured to, according to generation of the skipped frame, generate a predicted frame based on a preceding frame of the skipped frame among the plurality of image frames and motion information of the preceding frame, replace the skipped frame with the predicted frame, and output the predicted frame on a display.

The controller 110 may be further configured to identify any image frame among the plurality of image frames as the skipped frame based on motion information of an immediately preceding frame of the image frame.

The controller 110 may be further configured to identify the image frame as the skipped frame based on a pixel difference between the image frame and the immediately preceding frame being less than or equal to a reference value.

The controller 110 may be further configured to, based on the pixel difference being less than or equal to the reference value, exclude the image frame from the skipped frame according to a scene change between the immediately preceding frame and the image frame having occurred.

The controller 110 may be further configured to exclude the image frame from the skipped frame based on the pixel difference exceeding a first reference value, and identify the image frame as the skipped frame based on the pixel difference being less than a second reference value.

The controller 110 may be further configured to, based on generation of the skipped frame, generate a histogram of a magnitude of a motion vector included in the motion information.

The controller 110 may be further configured to, based on similarity of the histogram, generate the predicted frame.

The controller 110 may be further configured to, based on the plurality of image frames being an image of which a frame rate has been converted, remove an overlapping frame from the plurality of image frames and replace the skipped frame with the predicted frame.

A method of controlling a display apparatus 1 according to an embodiment may include sequentially receiving a plurality of image frames from an encoder 100, identifying at least one skipped frame from among the plurality of image frames, generating a predicted frame based on motion information of the plurality of image frames, and outputting the predicted frame replacing the skipped frame on a display.

The identifying of the skipped frame may include identifying any image frame among the plurality of image frames as the skipped frame based on motion information of an immediately preceding frame of the image frame.

The identifying of the skipped frame may include identifying the image frame as the skipped frame based on a pixel difference between the image frame and the immediately preceding frame being less than or equal to a reference value.

The method of controlling the display apparatus 1 according to an embodiment may further include, based on the pixel difference being less than or equal to the reference value, excluding the image frame from the skipped frame according to a scene change between the immediately preceding frame and the image frame having occurred.

The identifying of the skipped frame may include excluding the image frame from the skipped frame based on the pixel difference exceeding a first reference value, and identifying the image frame as the skipped frame based on the pixel difference being less than a second reference value.

According to the method of controlling the display apparatus 1 according to an embodiment may further include generating a histogram of a magnitude of a motion vector included in the motion information based on generation of the skip frame.

The generating of the predicted frame may include generating the predicted frame based on similarity of the histogram.

The outputting of the predicted frame replacing the skipped frame may include, based on the plurality of image frames being an image of which a frame rate has been converted, removing an overlapping frame from among the plurality of image frames and replacing the skipped frame with the predicted frame.

Therefore, the method of controlling the display apparatus according to an embodiment may, based on detection of a frame skip, predict a skipped frame by using previously input frames and output a predicted frame to thereby remove motion judder caused by the frame skip without a frame delay, and may apply a frame prediction technology to a frame rate converter to implement a frame rate converter without a frame delay.

Meanwhile, the disclosed embodiments may be implemented in the form of a recording medium that stores instructions executable by a computer. The instructions may be stored in the form of a program code, and when executed by the processor 111, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the recording media may include Read Only Memory (ROM), Random Access Memory (RAM), a magnetic tape, a magnetic disc, flash memory, an optical data storage device, etc.

Also, the computer-readable recording medium may be provided in the form of a non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment, the methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smart phones) directly. When distributed online, at least part of the computer program product (e.g., a downloadable app) may be temporarily generated or at least temporarily stored in the machine-readable storage medium, such as memory of the manufacturer's server, a server of the application store, or a relay server.

In one more embodiments of the present disclosure, a display apparatus may include: a frame buffer configured to sequentially receive a plurality of image frames; and a processor configured to: receive the plurality of image frames from the frame buffer and identify whether a skipped frame has been generated based on the plurality of image frames; based on generation of the skipped frame, generate a predicted frame based on a preceding frame of the skipped frame among the plurality of image frames and motion information of the preceding frame; and control a display to output the predicted frame replacing the skipped frame.

The processor may be further configured to identify an image frame among the plurality of image frames as the skipped frame based on the motion information of the preceding frame that immediately precedes the image frame.

The processor may be further configured to identify the image frame as the skipped frame based on a pixel difference between the image frame and the immediately preceding frame being less than or equal to a reference value.

The processor may be configured to, based on the pixel difference being less than or equal to the reference value, exclude the image frame from the skipped frame according to a scene change between the immediately preceding frame and the image frame having occurred.

The processor may be further configured to exclude the image frame from the skipped frame based on the pixel difference exceeding a first reference value, and identify the image frame as the skipped frame based on the pixel difference being less than a second reference value.

The processor may be further configured to, based on generation of the skipped frame, generate a histogram of a magnitude of a motion vector included in the motion information.

The processor may be further configured to, based on similarity of the histogram, generate the predicted frame.

The processor may be further configured to, based on the plurality of image frames being an image of which a frame rate has been converted, remove an overlapping frame from the plurality of image frames and replace the skipped frame with the predicted frame.

In one more embodiments of the present disclosure, a method of controlling a display apparatus may include: sequentially receiving a plurality of image frames; identifying at least one skipped frame from among the plurality of image frames; generating a predicted frame based on motion information of the plurality of image frames; and replacing the skipped frame with the predicted frame and outputting the predicted frame on a display.

The identifying of the skipped frame may include identifying an image frame among the plurality of image frames as the skipped frame based on motion information of an immediately preceding frame of the image frame.

The identifying of the skipped frame may include identifying the image frame as the skipped frame based on a pixel difference between the image frame and the immediately preceding frame being less than or equal to a reference value.

The method may include, based on the pixel difference being less than or equal to the reference value, excluding the image frame from the skipped frame according to a scene change between the immediately preceding frame and the image frame having occurred.

The identifying of the skipped frame may include excluding the image frame from the skipped frame based on the pixel difference exceeding a first reference value, and identifying the image frame as the skipped frame based on the pixel difference being less than a second reference value.

In one more embodiments of the present disclosure, a display apparatus may include: a frame buffer configured to sequentially receive a plurality of image frames; and a processor configured to receive the plurality of image frames from the frame buffer and generate a predicted frame based on the plurality of image frames, wherein the processor may be configured to: identify an output location of the predicted frame by detecting an image frame conversion rate; generate the predicted frame based on a preceding frame of a frame corresponding to the output location and motion information of the preceding frame; and output the predicted frame at the output location of the predicted frame.

The processor may be further configured to remove an overlapping frame from among the plurality of image frames based on the image frame conversion rate, and identify a location of the overlapping frame as the output location of the predicted frame.

So far, specific embodiments have been shown and described, however, the disclosure is not limited to these embodiments. It should be interpreted that various modifications may be made by one of ordinary skill in the technical art to which the disclosure belongs, without deviating from the gist of the technical concept of the disclosure, which is defined in the following claims.

What is claimed is:

1. A display apparatus comprising:
a frame buffer configured to sequentially receive a plurality of image frames; and
a processor configured to:
receive the plurality of image frames from the frame buffer and identify whether a skipped frame has been generated based on the plurality of image frames;
based on generation of the skipped frame, generate a predicted frame based on a preceding frame of the skipped frame among the plurality of image frames and motion information of the preceding frame; and
control a display to output the predicted frame replacing the skipped frame.

2. The display apparatus of claim 1, wherein
the processor is further configured to identify an image frame among the plurality of image frames as the skipped frame based on the motion information of the preceding frame that immediately precedes the image frame.

3. The display apparatus of claim 2, wherein
the processor is further configured to identify the image frame as the skipped frame based on a pixel difference between the image frame and the immediately preceding frame being less than or equal to a reference value.

4. The display apparatus of claim 3, wherein
the processor is configured to, based on the pixel difference being less than or equal to the reference value, exclude the image frame from the skipped frame according to a scene change between the immediately preceding frame and the image frame having occurred.

5. The display apparatus of claim 3, wherein
the processor is further configured to exclude the image frame from the skipped frame based on the pixel difference exceeding a first reference value, and identify the image frame as the skipped frame based on the pixel difference being less than a second reference value.

6. The display apparatus of claim 1, wherein
the processor is further configured to, based on generation of the skipped frame, generate a histogram of a magnitude of a motion vector included in the motion information.

7. The display apparatus of claim 6, wherein
the processor is further configured to, based on similarity of the histogram, generate the predicted frame.

8. The display apparatus of claim 1, wherein
the processor is further configured to, based on the plurality of image frames being an image of which a frame rate has been converted, remove an overlapping frame from the plurality of image frames and replace the skipped frame with the predicted frame.

9. A method of controlling a display apparatus, the method comprising:
sequentially receiving a plurality of image frames;
identifying at least one skipped frame from among the plurality of image frames;
generating a predicted frame based on motion information of the plurality of image frames; and
replacing the skipped frame with the predicted frame and outputting the predicted frame on a display.

10. The method of claim 9, wherein
the identifying of the skipped frame comprises
identifying an image frame among the plurality of image frames as the skipped frame based on motion information of an immediately preceding frame of the image frame.

11. The method of claim 10, wherein
the identifying of the skipped frame comprises
identifying the image frame as the skipped frame based on a pixel difference between the image frame and the immediately preceding frame being less than or equal to a reference value.

12. The method of claim 11, further comprising,
based on the pixel difference being less than or equal to the reference value, excluding the image frame from the skipped frame according to a scene change between the immediately preceding frame and the image frame having occurred.

13. The method of claim 11, wherein
the identifying of the skipped frame comprises
excluding the image frame from the skipped frame based on the pixel difference exceeding a first reference value, and identifying the image frame as the skipped frame based on the pixel difference being less than a second reference value.

14. A display apparatus comprising:
a frame buffer configured to sequentially receive a plurality of image frames; and
a processor configured to receive the plurality of image frames from the frame buffer and generate a predicted frame based on the plurality of image frames,
wherein the processor is configured to:
identify an output location of the predicted frame by detecting an image frame conversion rate;
generate the predicted frame based on a preceding frame of a frame corresponding to the output location and motion information of the preceding frame; and
output the predicted frame at the output location of the predicted frame.

15. The display apparatus of claim 14, wherein
the processor is further configured to remove an overlapping frame from among the plurality of image frames based on the image frame conversion rate, and identify a location of the overlapping frame as the output location of the predicted frame.
